(19) United States
(12) Patent Application Publication
(10) Pub. No.: US 2008/0082568 A1
(43) Pub. Date: Apr. 3, 2008

(54) System and method for managing and utilizing information

(75) Inventors: Greg Miller, Asbury, NJ (US); Kevin McMurtry, Basking Ridge, NJ (US); Jeffrey Brady, Jersey City, NJ (US)

Correspondence Address: GIBBONS P.C., ONE GATEWAY CENTER, NEWARK, NJ, 07102, US

(73) Assignee: Advanced Health Media, Inc.

(21) Appl. No.: 11/827,743

(22) Filed: Jul. 13, 2007

Related U.S. Application Data
(63) Continuation of application No. 10/949,824, filed on Sep. 24, 2004, now abandoned.
(60) Provisional application No. 60/506,024, filed on Sep. 24, 2003.
(60) Provisional application No. 60/551,550, filed on Mar. 9, 2004.

(51) Int. Cl. G06F 7/10; G06F 17/30

(52) U.S. Cl. 707/102; 707/E17.005

(57) ABSTRACT

A computer-readable medium including computer-executable instructions for managing information associated with a plurality of electronic documents, the computer-executable instructions including: instructions for displaying a hierarchically organized list of user selectable keywords; instructions for associating at least some of the electronic documents with selected ones of the keywords; instructions for associating at least some of the electronic documents with at least one meeting, conference or event; and instructions for automatically displaying a list of ones of the electronic documents associated with at least one of the keywords and meetings, conferences or events responsively to a user request therefore.

### CROSS REFERENCE TO RELATED APPLICATIONS

This application is a continuation application of U.S. patent application Ser. No. 10/949,824, entitled SYSTEM AND METHOD FOR MANAGING AND UTILIZING INFORMATION, filed Sep. 24, 2004, which claims priority of U.S. Provisional Patent Application Ser. No. 60/506,024 entitled “SYSTEM AND METHOD FOR A PLANNER,” filed Sep. 24, 2003, and provisional patent application U.S. Ser. No. 60/551,550, filed Mar. 9, 2004, which are all hereby incorporated herein as if set forth herein in their respective entireties.

### FIELD OF THE INVENTION

The invention relates to an organizer, and, more specifically, to a system and method for storing and tracking slides, abstracts, articles, posters, press releases, and/or related published information.

### BACKGROUND OF THE INVENTION

Today's business environment demands that information be effectively distributed between business principals and management, peers, subordinates, supporting departments, suppliers, customers, clients, and any number of authorities, such as government regulatory bodies. Restraints placed on the dissemination of information may include document availability, such as access limited by authorization, location, format, and type.

The availability of information can be limited by technology, such as by the absence of a central or assessable repository. For instance, an article written by one author may be written in an electronic format but distributed only to select colleagues via email, for example. The same article may also be password protected or limited in accessibility to those working in the same group, or for the same company, due to software or firewall restrictions, for example. Further, the location where at the article resides may also be a limitation on access. Again, an electronic version of an article may reside on a server not accessible or searchable by a party interested in the article, and may not even be brought to the attention of an interested party in the first place. Format may also restrict the viewing and use of the article if not accessible by colleagues, and formatting may limit distribution, if at all, to only a select few. Additionally, if the information sought is in the form of, for example, an article, a person looking for a press release covering the same information as the article may not obtain the information sought.

Thus, there is a need for an invention that provides a systematic solution to information management and dissemination. The present invention addresses these issues by providing a systematic apparatus and method for assisting information seekers in managing, organizing, searching, and disseminating information.

### SUMMARY OF THE INVENTION

The present invention is directed to an information management system, comprising: An information management system, comprising: an administrator, wherein at least one information item is received at the administrator, at least one database, wherein the at least one information item is stored, an associator, wherein refinement of the at least one information item is performed by said associator by associating the at least one information item with at least one data attribute selected by the administrator from a plurality of data attributes, and wherein the association of the selected ones of the data attributes with the at least one information item are stored to said at least one database, and a logistical disseminator, wherein said logistical disseminator manipulates the selected ones of the data attributes and the information item associated therewith in accordance with an output request, and in accordance with unique limitations of one or more of the selected ones of the data attributes, and wherein the manipulation is in accordance with at least one output selected from the group consisting of a report, a search result, and an editor's choice.

The present invention also includes a method for managing information, said method comprising: receiving a logging onto the application, accessing an input, wherein an item of information is accepted at the input, accessing an administrator, wherein said administrator assigns at least one of a plurality of data attributes to the information, utilizing at least one database, wherein assigned ones of the plurality of data attributes are associated with the information and stored, accessing a logistical disseminator, wherein said logistical disseminator manipulates the selected ones of the data attributes and the information item associated therewith in accordance with an output request, and in accordance with unique limitations of one or more of the selected ones of the data attributes, and wherein the manipulation is in accordance with at least one output selected from the group consisting of a report, a search result, and an editor's choice, receiving an identification of the authors of the data, and receiving an identification of the type of the data.

The present invention also includes an apparatus for storage and retrieval of information, comprising: an input, wherein an item of information is accepted at the input, an administrator, wherein said administrator assigns at least one of a plurality of data attributes to the information, at least one database, wherein assigned ones of the plurality of data attributes are associated with the information and stored, and at least one disseminator, wherein said disseminator retrieves the information and the associated ones of the data attributes from the at least one database responsive to an inquiry including at least one of the associated ones of the data attributes, and wherein said disseminator retrieves the information and associated ones of the data attributes from the at least one database responsive to an inquiry including at least a portion of the information.

The present invention solves problems experienced with the prior art because it provides a systematic solution to information management and dessemination. Those and other advantages and benefits of the present invention will become apparent from the detailed description of the invention hereinbelow.

### BRIEF DESCRIPTION OF THE DRAWINGS

Understanding of the present invention will be facilitated by consideration of the following detailed description of a preferred embodiment of the present invention taken in conjunction with the accompanying drawings, in which like numerals refer to like parts and in which:

FIG. 1 is a block diagram of the present invention;

FIG. 2 is a block diagram of the present invention; and

FIGS. 3-38 are embodiments of displays of the current invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical system and method. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure herein below is directed to all such variations and modifications to planning technologies known, and as will be apparent, to those skilled in the art.

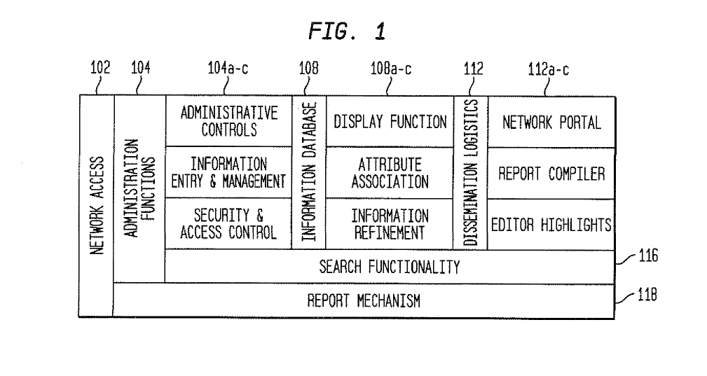

A knowledge management system in accordance with the present invention is shown in FIG. 1. The knowledge management system may be utilized, for example, for collecting, storing, and disseminating information and ideas. Users may search, view, and organize information related to at least one document. Administrators may interact with the knowledge management system to add information, provide interactive guidance on document selection and control the flow of information, for example. Administrators may additionally control the use and content of the knowledge management system. The knowledge management system may include network access 102 to administration function modules 104, at least one database, such as an information database 108, for example, and dissemination logistics module 112. The knowledge management system may also include a search functionality module 116, for example. The knowledge management system may be, or may include, for example, a Microsoft Windows distributed internet applications architecture, as discussed further herein below.

The administration function module 104 may include administrative controls, information entry and management, and security and access control 104a-c. The information database 108 may include display function module, attribute association module, and information refinement 108a-c. The dissemination logistics module 112 may include network portal, report compiler and editor highlights 112a-c. The dissemination logistics module 112 may further have the ability to manipulate and identify select data attributes and any associated information. These functions may be supported by search functionality module 116 and report mechanism module 118.

The knowledge management system of FIG. 1 may include this multiplicity of integrated components and at least one logical and/or relational database. A document in the knowledge management system may necessitate or include one or more of the functions or modules of FIG. 1, depending on the requirements of the user. A document is at least one group of information of at least one type of information contained in the knowledge management system. Information can be in the form of, for example, articles, posters, slides, letters and abstracts. Information may also include author, title, date, location and format, for example. Thus, for each piece of information, there may be a set of data attributes that may be tracked. Some of the data attributes for each piece may be required, and others may be used at the administrator's discretion.

The knowledge management system may utilize, for example, dynamic link libraries (DLL) that link the information data, such as the administrator's choice of component and fields, and HTML, xml, or ASPX templates, for example. These DLLs may process the HTML templates before presentation to a user of the interface, replacing tags and information in the HTML template with the defining attributes captured. Thereby, the administrator may have control of the layout and presentation of the data, and the knowledge management system may thus ensure that capture validation and storage of data is consistent across all information.

The information database 108 may include display function module, attribute association module, such as an associator, for example, and information refinement, for example. The display function module may control the fields shown to the user, and may include the ability to hide or reveal attributes and respond to user access privilege logic, for example. Further, one or more attributes may be associated to information in the knowledge management system. An attribute may include an author's identity, title of work, type of information, disclosure elements, keywords, other pieces of information, for example. One or more information pieces may be refined by attribute. Refinement may include, for example, sorting and/or filtering.

The reporting may report real-time status of user activities, for example, a tabular format including site usage by functionality, hits to the knowledge management system, user browser environment, user referral information and individual user usage. Reporting may be a real time, Internet-based format for secure access from any computer having access to the network, such as the internet or an intranet, on which the knowledge management system is resident. Users may, for example, export and download a report in Microsoft Excel format to a local machine from the reporting module. Pre-defined reports may be available for any selected period.

Security access control 102c may authenticate a user. Users of the system may log into the system via an internet portal and access the system through the protections of a user name and password, for example. In addition, the security module may provide access control once the user has been authenticated. Multiple levels of access control may be defined. For example, one level may be for system administrators and another may be for a client user. System administrators may have full access to the application to add, delete and update the data, and client users may have limited access.

An auditing function may additionally be provided. The knowledge management system may track creations, reads, updates, additions, edits and deletions from the databases, in order to provide a history of changes for auditing. The audit log may grow very large, and thus may require periodic purging. The audit log may track systems usage and help to resolve issues regarding data quality. Each audit record may be corresponded to a field in the person or place database or in the data captured, and may include a user ID and the date and time of any modification made, along with the new value for the field.

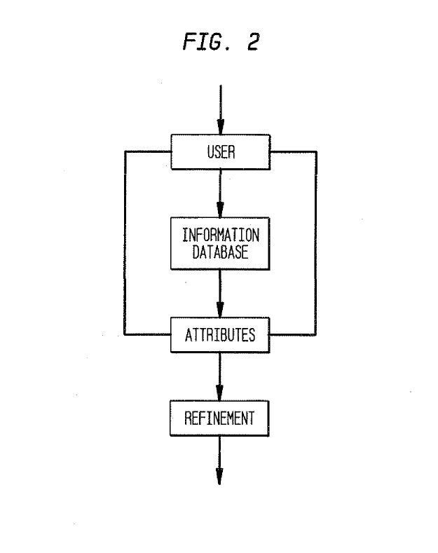

FIG. 2 represents an exemplary database, which may be, or be within, for example, an information listing. The information listing may provide a common store for any information and/or attribute data. Providing references to information in a single table may provide a consistent, normalized view of the data, and may provide a common access point for critical stores of information. Each piece of information may be stored in the information database, thereby providing a common value for all sub-systems. This common-valuing may allow analysis of attribute data across all information types.

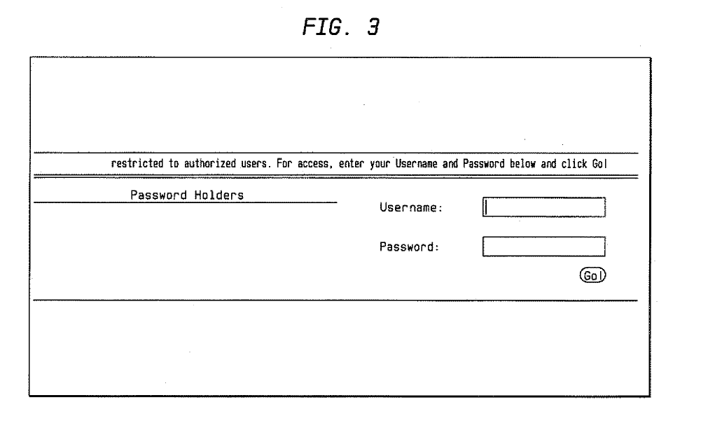

In operation, a user may log-in, and that log-in may alert the knowledge management system as to the functions to which that user may be granted access, and, if access is granted, to what level access may be exerted. Once connected and authenticated, the knowledge management system may offer the user a menu of available choices. In an embodiment of the present invention shown in FIG. 3, users are prompted to enter a user name and password for access to the system. User name and passwords may be assigned before a user accesses the system, or may be created by a user or an authorized user of the system. If an unrecognized or invalid user name or password is entered and submitted to the system, the system may respond by allowing the user to try again, or may, alternatively, deny access to the knowledge management system. The user may also contact the administrator via phone, e-mail or through a provided help screen. If a recognized user name and password is entered into the fields provided in FIG. 3 and the user clicks on the “Go” icon, the user may be permitted to enter the knowledge management system.

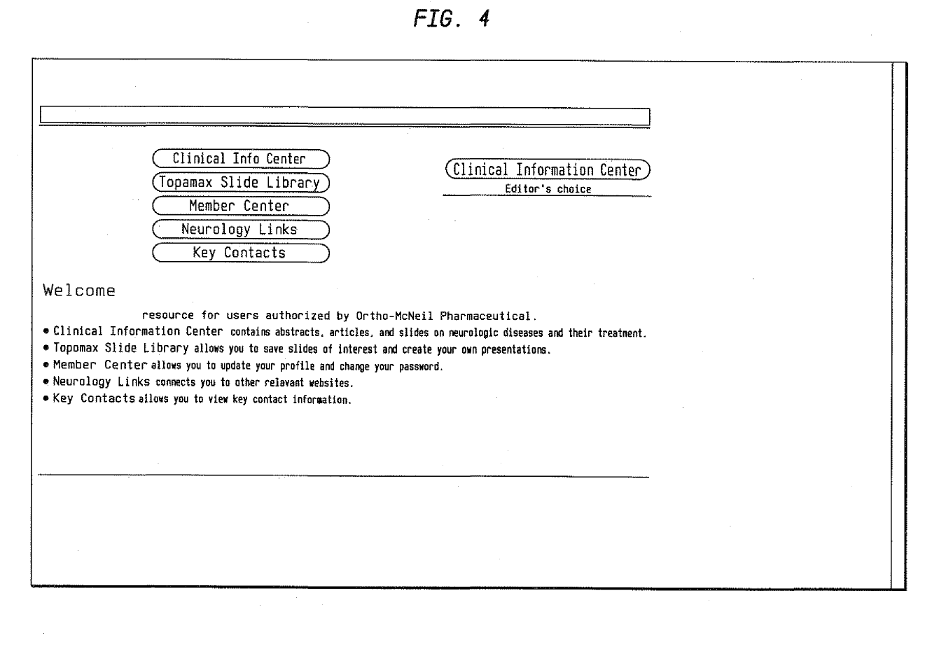

FIG. 4 is an embodiment of the main menu of the knowledge management system, and the embodiment may include buttons for accessing various modules of the application such as: clinical information center, slide library, member center, links, and key contacts. Accessing the clinical information center may provide a user with an extensive library of abstracts, articles and slides, and other document types pertaining to medical conditions and treatment approaches such as, for example, slides on diseases and treatments. The slide library may allow a user to create, view and save presentations based on material contained within the knowledge management system and information entered by the user. The member center may allow a user to update profiles for which the user has authorization, and to change user name and passwords. Links may connect the user to relevant web sites contained within the knowledge management system, and key contacts may allow a user to view key contacts information provided by the knowledge management system. Additionally, as shown by FIG. 4, the main menu of the knowledge management system may include document links under the clinical information center. These document links may provide the user access to regularly updated user specific documents, which may include recommendations made by the administrator. By clicking on the document link a user may automatically be presented with the target material.

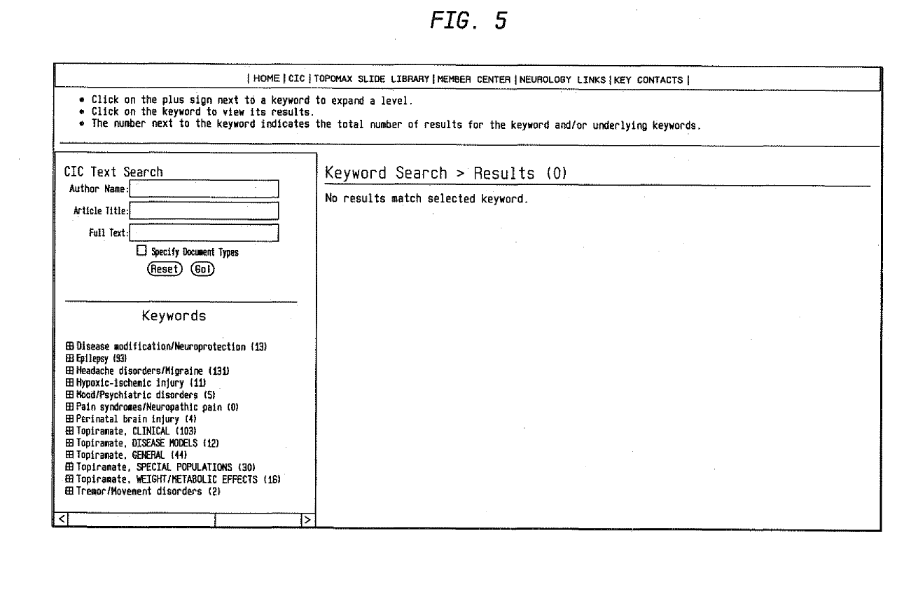

By clicking on the clinical information center button, as illustrated in FIG. 4, the user may be presented with another embodiment of the present invention as illustrated in FIG. 5. An embodiment of a knowledge management system search window, as illustrated in FIG. 5, may provide the user with the ability to search information such as, for example, abstract, articles and slides by text search method or keyword method. A text search method, as will be known by those skilled in the art, may allow the user to search specific text strings within defined fields. By way of non-limiting example only, a user may search the knowledge management system database for documents by an author's name, article title or specific text strings contained within the body of the document. As shown, FIG. 5 may thus provide a text search portion with fields suitable for text searching an author's name, article title and full text, for example. A user using this search technique may enter one or more text strings in one or more search fields. By way of non-limiting example only, a user may enter an author's last name and part or a portion of an article title. The user may then click the “Go” button and the knowledge management system may search the database for documents with the author's last name and the given text string in the article title. Further, a user may enter at least one text string in the full text field, thus allowing the user to search documents for specific text strings. By way of non-limiting example only, a user may enter the text “carcinoma” with the knowledge management system to return all documents with the text string carcinoma included therein. The user may also request that results returned by the knowledge management system include the document type of the found document, for example, abstract, article or slide. As will be known to those skilled in the art, and as will be applicable to searching utilizing the knowledge management system, truncation of text strings and the use of wildcards may be used.

The knowledge management system search window, as illustrated in FIG. 5, also includes the ability to search by keywords. Keywords may include text strings specific to the type of information contained in the knowledge management system and may further be added to the system at any time. The keyword search may be divided in hierarchical classes of keywords, further including sub-groups accessible by clicking the “plus” icon, thus expanding the sub-categories listed under each major keyword category. Additionally, each category may have next to the text string, such as listed in parenthesis, the number of lower level sub-categories included in that major category. By way of non-limiting example only, in a medical application, keyword top level categories may include such text strings as Epilepsy, Headache Disorders/Migraines, Hypoxic-Ischemic Injury, Mood/Psychiatric Disorders, Pain Syndromes/Neureopathic Pain, Perinatal Brain Injury, Topiramate: Clinical, Topiramate: Disease Models, Topiramate: General, Topiramate: Special Populations, Topiramate Weight/Metabolic Effects, And Tremor/Movement Disorders, for example.

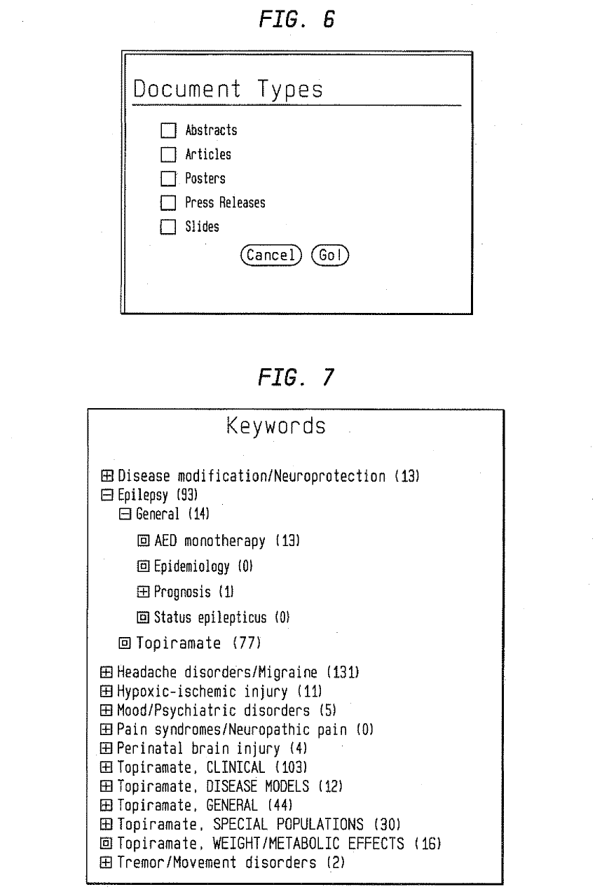

By selecting the specified documents type box from the text search portion of the knowledge management system search window, a user may have the ability to choose from a variety document types, as illustrated in FIG. 6. This document type selection window includes documents, such as abstracts, articles, posters, press releases and slides, for example. A user may select all, none or multiple document types to be searched. Once the user has made a selection, clicking the “Go” button may set the current search document types.

The top level categories and lower level category topics of the keyword search portion of FIG. 5 are illustrated in FIG. 7. Although the number of documents and/or sub-categories contained in each topic area may be identified next to the keyword text string, this number may be zero. By way of non-limiting example only, the top level topic of “Epilepsy” may have a sub-category topic entitled “General,” with further sub-category topics ranging from “AEP Monotherapy” to “Epidemilogy Prognosis,” for example. Additionally, sub-category keywords may also be expandable to include further sub-categories. The levels of keyword topics may be further identified with symbols such as plus, minus or square symbols. The plus symbol may indicate that sub-categories exist for that particular keyword and the minus symbol may indicate that all sub-categories have been displayed. The square symbol may further indicate that no sub-categories exist for that keyword. This use of symbols to identify the existence of additional sub-categories, in addition to the identification of the number of documents per sub-category, may allow the user quick access to the keyword search made available by the knowledge management system.

Search results may be displayed in the search results window, as illustrated in FIG. 8. This window may include a total of the number of results retrieved, a document type key, and the individual search results, including, for example, appropriate document icons and appropriate document information. At the top of each search results window the knowledge management system may provide a numerical sum of all results captured in the search presently run.

The knowledge management system may also present a document type key, as illustrated in FIG. 8, associating certain document types with particular icons. The document key not only provides a visual representation of the particular document type for the ease of use of the user, but may also be accessed as an active hyper-linked icon by clicking on the individual document key icon for more information about that document type. Following the document type key in the search results window may be a table-formatted listing of the results acquired by the search. These results may be first annotated with a document type key indicating the type of document that has been returned. Further, the search results may display, for example, the document author, title, summary, format and citation. The document type key icon associated with each search result may be clicked to open the document(s). This allows a user to quickly scan the list for appropriate titles or, if more desirable, a particular document type. The user may also experience further time savings by being able to open the search results from the search results window of the present knowledge management system.

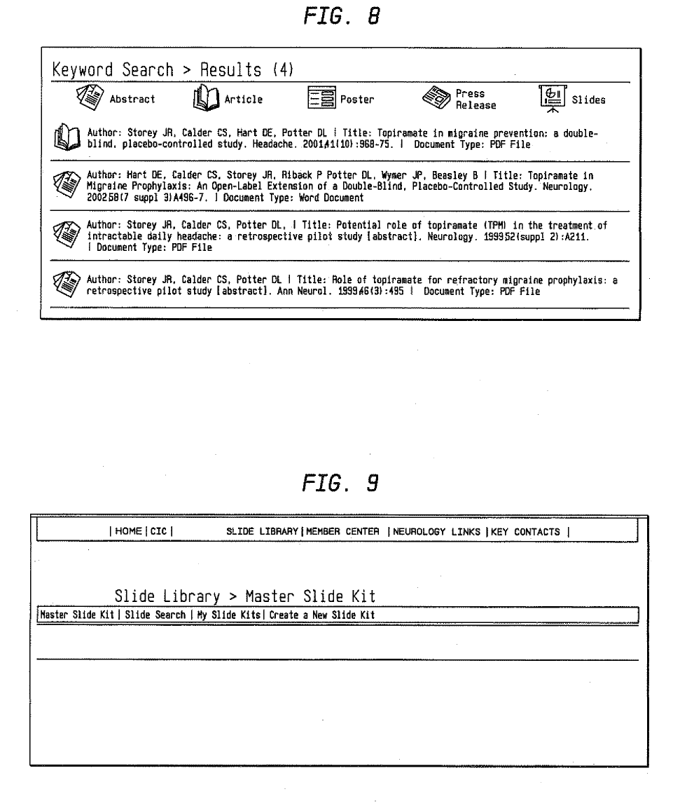

As shown in FIG. 4, the user of the knowledge management system may also click the button labeled slide library to gain access to a knowledge management system and a method for managing and creating presentations, as illustrated in FIG. 9.

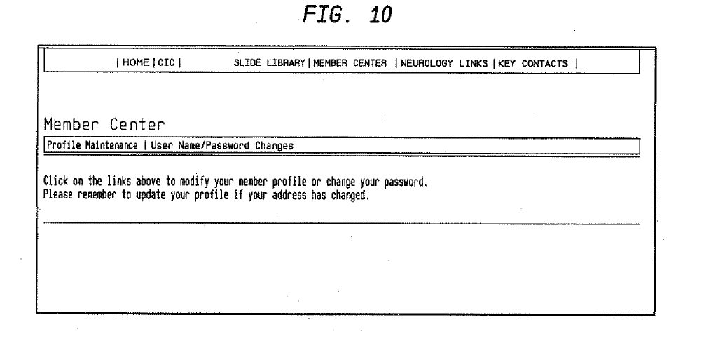

Users of the knowledge management system may choose to click the member center link from the main menu illustrated in FIG. 4. The user may then have access to the member center window of the knowledge management system illustrated in FIG. 10. This window may provide the user the ability to access and update personal information, as well as change user name or password. Access to personal information may be provided by, for example, a profile maintenance while access to change user name and password may be accessed clicking the link labeled same.

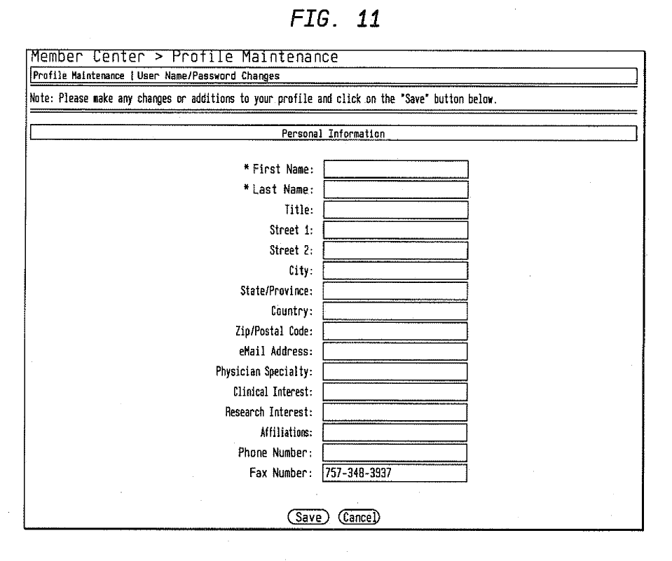

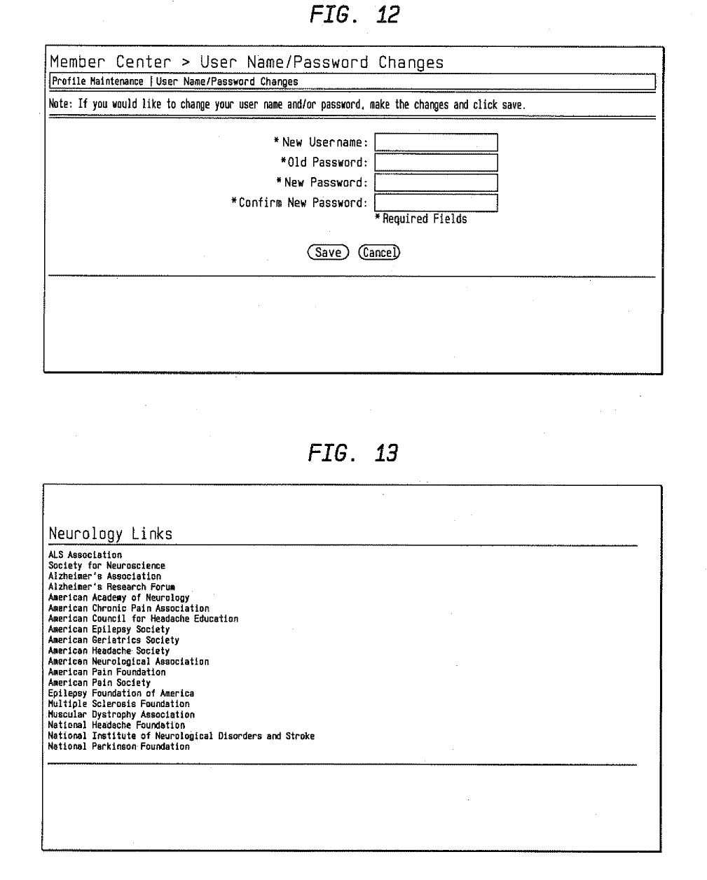

By clicking the link labeled profile maintenance from the member center window, as illustrated in FIG. 10, a user may move to the profile maintenance window as illustrated in FIG. 11. A profile maintenance window may allow the user to enter personal information such as first name, last name, address, e-mail address, specialty, interests, affiliations, phone number and fax number, for example. This profile maintenance window may also be used to add information to a new user, or to change information for a current user of the knowledge management system. When information is added or edited the knowledge management system, users may save this personal information by clicking a save button from within the profile maintenance window. The member center window, as illustrated in FIG. 10, also provides a link to the user name and password changes window, as illustrated in FIG. 12. Users of the knowledge management system may add new user name and password information, or change and edit existing user name and password information. As described previously, users may save these additions or changes by clicking the save button in the user name/password changes window.

Further, from the knowledge management system main menu window illustrated in FIG. 4, users may click links to access the links window as illustrated in FIG. 13. The links window of the present invention may provide a list of related web links on pertinent topics. Such topics may be dictated by the users of the knowledge management system, and may or may not be limited to any particular field. By way of non-limiting example only, such links may deal with the field of neurology. Related web links thus may include, by way of further example, ALS Association, Society for Neuroscience, Alzheimer's Association, American Academy of Neurology, and American Epilepsy Society. Each link in the links window may be provided as a text string hyperlink, thereby allowing the user to navigate away from the knowledge management system web site by clicking on the desired text string link. By way of non-limiting example only, if a user desired to know more about the ALS Association, the user would click on the ALS Association link in the links window and then navigate through the network over the internet to the ALS Association's web site, if appropriately pointed to the appropriate web site.

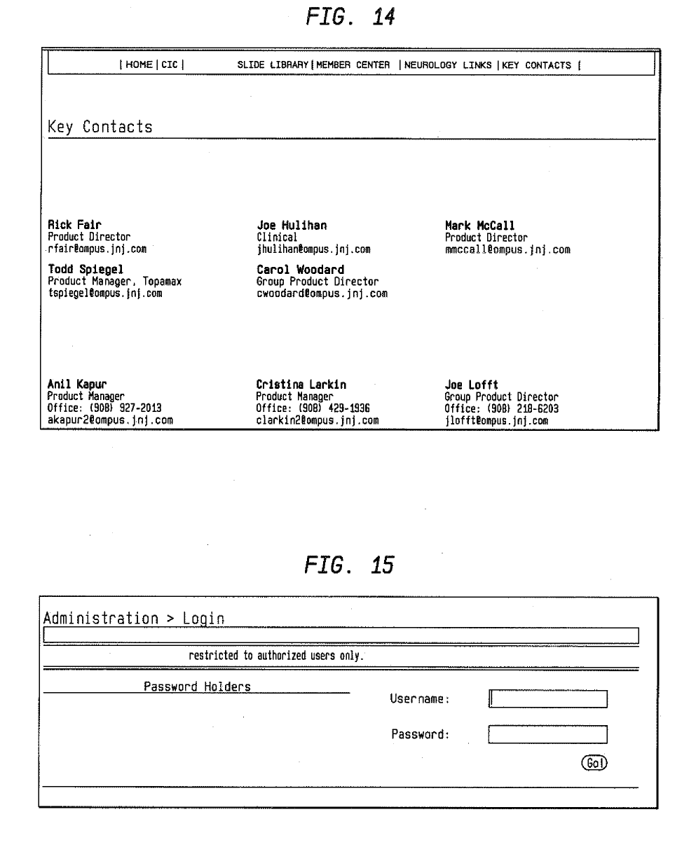

Additionally, a user may click on a key contacts button from the knowledge management system main menu illustrated in FIG. 4, to access the key contacts window illustrated by FIG. 14. The key contacts window may include a listing of contact information for subject matter experts, key professionals, other users of the knowledge management system and industry contacts, for example. The information included for each key contact may include name, telephone number, contact address, e-mail address, professional affiliation, company and title for example. The e-mail portion of the contact information may also be utilized as a hyperlink, thereby allowing the user of the knowledge management system to e-mail a key contact by clicking on a web e-mail address.

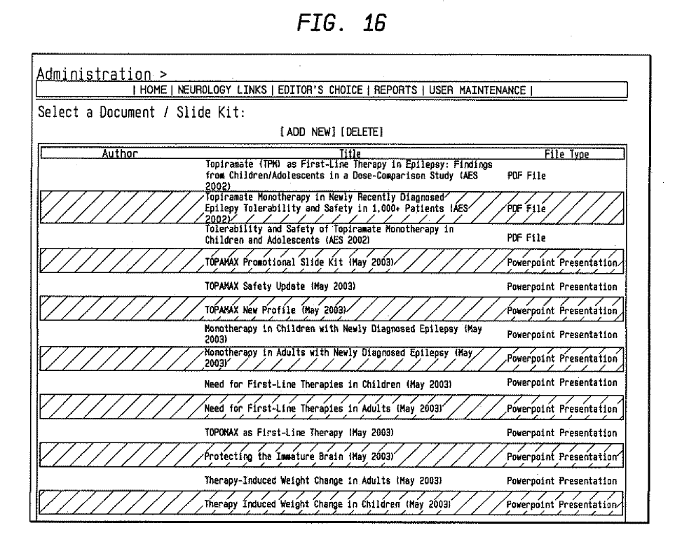

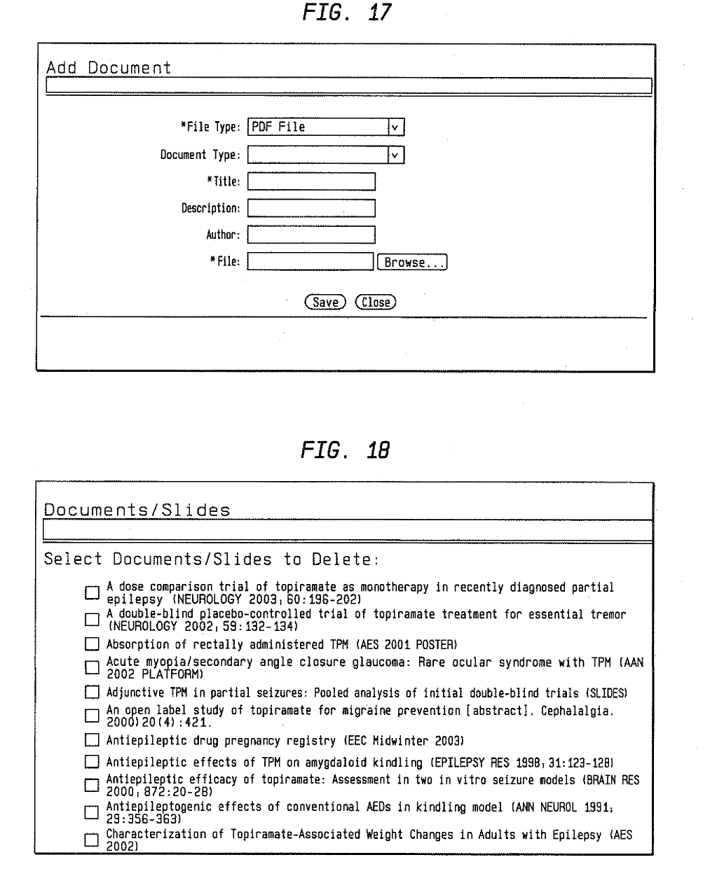

The present knowledge management system may provide for administrative control over the contents of, and access to, the knowledge management system. Thus, a user may be an administrator and may be responsible for adding, removing and maintaining documents within the knowledge management system. Additionally, an administrator may control user access and other contents of the knowledge management system. As illustrated in FIG. 15, the knowledge management system may provide an administration log-in window. This window may allow authorized personnel to enter a valid user name and password which may allow them to access the knowledge management system by clicking the “Go” button. Successful log-ins may lead the user to the knowledge management system administration main window illustrated in FIG. 16. This main window may include links allowing the user to navigate to the home main menu, to the links page, the editors choice administration page, the reports window and the user maintenance window, for example. The main window may also provide a listing of documents contained in the knowledge management system. The user may further have the ability to add documents to the knowledge management system, remove existing documents from the knowledge management system, or access existing documents for the purposes of editing, such as to assign or update associated search criteria, for example. By clicking the add new link button in the administration main window, the user may move to the administration add document window illustrated in FIG. 17.

This window may allow the administrator to add new documents to the knowledge management system. The administrator may choose to designate characteristics, such as file type, document type, title, description and author, for example. The administrator may also add a file by completing, in the file field, the location of the document, or by selecting the document by clicking the browse button to search for the document by techniques known to those skilled in the art.

The file types available to the administrator may include .PDF, .PPT, .HTML .DOC, .TXT and .WPD, for example. The document types available to the administrator may include, as discussed above, abstracts, articles, poster, press releases and slides, for example. The title, description, and author fields may be manually populated by the administrator as appropriate. When at least one of the above mentioned fields is populated, the administrator may choose to save the addition of the document by clicking the save button, thereby to save characteristics of the document to the knowledge management system and to upload the document to the knowledge management system, for example. Conversely, an administrator may delete documents from the knowledge management system by choosing the delete link, as illustrated in FIG. 16, which may move the administrator to the administration delete document window, as illustrated in FIG. 18.

The delete document window may include a listing of all or a portion of the documents included in the knowledge management system. This list of documents may further be sorted by year, source, author, title and file type, for example. The list of documents in this window may also include an option box associated with each document. This option box may allow the user to choose and select documents desired to be deleted from the knowledge management system. If one or more documents are selected by checking the option box associated with the particular document, those documents may be deleted from the knowledge management system by clicking the delete button at the bottom, which may be of the delete document window.

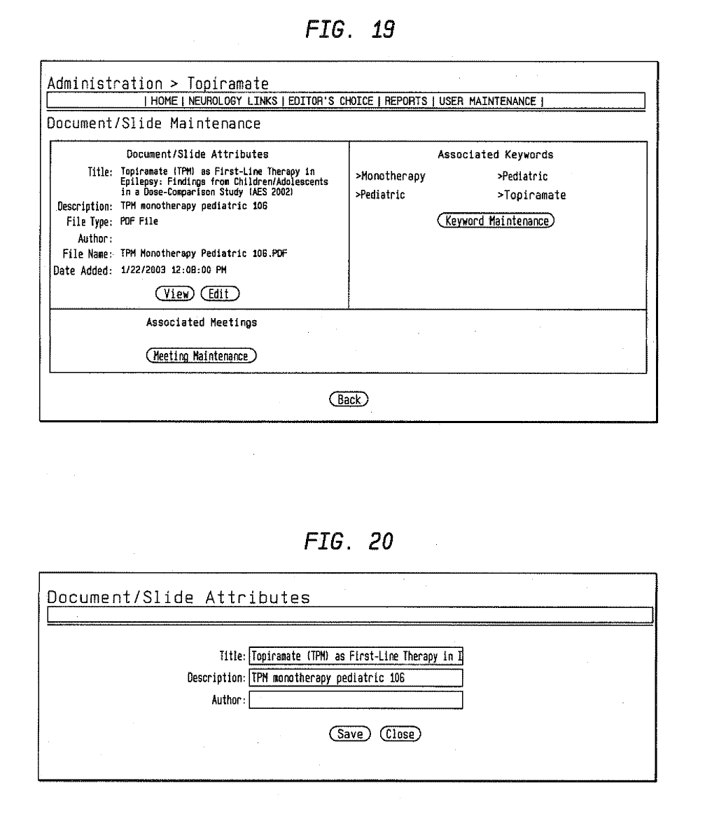

Once a document is added to the knowledge management system, such as in the exemplary manners discussed above, the administrator may specify unique document information to further refine user searches. An administrator may be encouraged to associate attributes and keywords, for example, and meetings with each document to provide users with more complete research results. The ability to assign attributes to individual documents is illustrated by FIG. 19, which is a document maintenance window. This window may be accessed by clicking on a document from the administration main window, as illustrated in FIG. 16. Along with a hot link bar that may be associated with all administration windows, the document maintenance window may include document/slide attributes, a listing of associated keywords, and a list of associated meetings, for example.

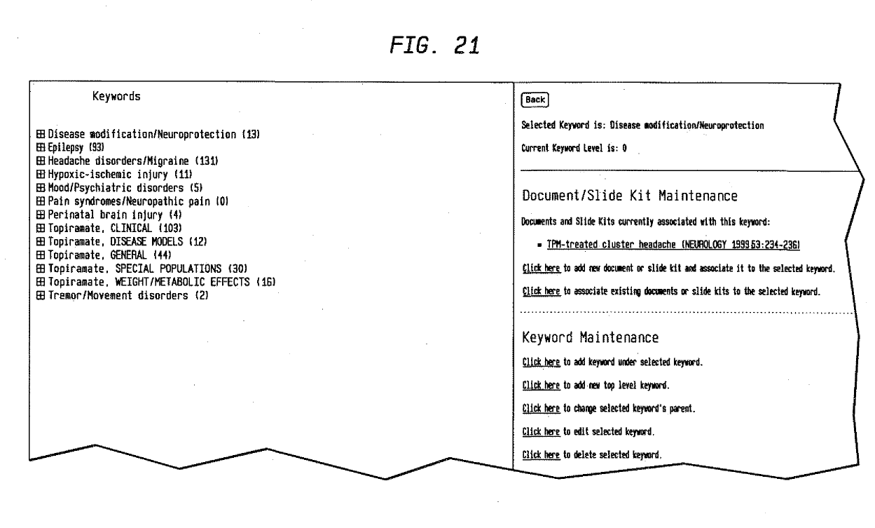

Information contained in the document/slide attributes portion of document maintenance window may include title, description, file type, author, file name, and date added to the knowledge management system, for example. This information may be viewed or edited for content by clicking the viewer edit buttons in the document/slide attributes portion. Clicking the edit button may allow an administrator to add or update document attributes, as illustrated in FIG. 20. Document/slide attributes may include title, description and author, for example. Additions or changes in the document attributes window may be saved to the knowledge management system by clicking the save button.

As previously stated, once a document is added to the knowledge management system, an administrator may specify unique document information to further refine uses searches. The associated keywords portion, as provided in the document maintenance window for the document currently being added or edited by the administrator, may allow the administrator to add or modify the associated keywords by clicking the keyword maintenance button to provide access to the keyword administration window, as illustrated in FIG. 21.

As further illustrated in FIG. 19, keywords may be associated with the documents contained in the knowledge management system. By clicking the button labeled keyword maintenance, the user may be forwarded to the keyword administration window illustrated in FIG. 21. The keyword administration window may be divided in two portions. The first portion may contain keywords already included within the knowledge management system, while the second portion may provide functionality allowing the association of existing keywords with existing and newly created documents within the knowledge management system. In the first portion, keywords already existing in the knowledge management system, as entered by the administrator and as more thoroughly described above, may be organized in top level and lower level categories, each with sublevel access using the plus symbol icon as described above.

The association of keywords with the multiple document types contained within the knowledge management system allows a user to properly categorize a particular document, and allows the user to categorize the document as it is entered into the knowledge management system or as it is created using the knowledge management system, or allows the user to view within the knowledge management system. Thereby, the present invention provides a highly accurate classification within the knowledge management system, which may be based on the familiarity of the user with the subject matter.

Once a keyword is selected from the categories or subcategories of the first portion, the user may then associate that keyword with the present document. The direct association of a keyword with a particular document may be accomplished using the second portion of the keyword maintenance window. The selected keyword or category from the first portion may be individually highlighted in the second portion to more clearly identify to the user which keyword has been selected. The user may then have the option to associate the chosen keyword with a document, or may associate the keyword to an existing document. Each of these options may be chosen by clicking buttons designating each option within the second portion. The second portion may also display other documents contained within the knowledge management system, which may already be indexed by the chosen keyword. This allows the user to view and analyze the association other users have made between the keywords and other documents contained within the knowledge management system. This feature may further assist the user in properly classifying documents by allowing the user to view and understand the logic used to classify existing documents by other users.

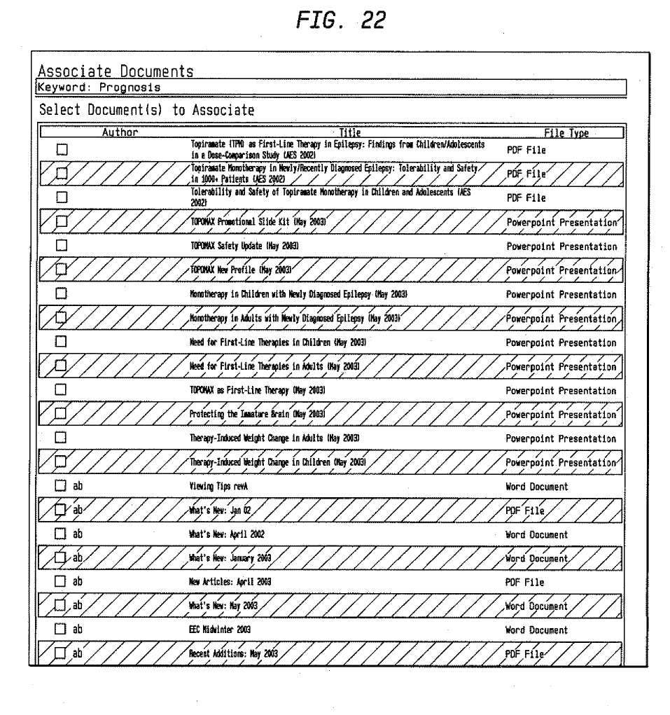

A user who chooses to associate a keyword to a new document may click on the link provided and may be taken to the keyword association list window illustrated in FIG. 22. The keyword association window may provide access to all documents contained within the knowledge management system. The window may display the keyword chosen associated with one or more documents within the knowledge management system, and a table containing a listing of the documents contained within the knowledge management system. The documents may be listed in any order, including alphabetically by keywords or associated keyword, author, title and file type, for example. Each listed document may also contain an option box allowing the user to click whether or not that document should be associated with the presently selected keyword. Once one or more documents have been selected to be associated with the keyword, unselected documents may be removed from being associated with the keyword, and the user may navigate to the bottom of the window and click the save button. This function will update the knowledge management system with the association of the keyword with the documents selected.

As further illustrated in FIG. 21, the second portion of the keyword administration window may allow for keyword maintenance. This keyword maintenance portion may allow a user to change keyword hierarchy, add new keywords, delete new keywords and edit new keywords, for example. A user may access particular functions by clicking on the “Click Here” hyperlink, in the keyword maintenance portion, that is associated with the sentence outlining the desired functionality. For example, “Click Here” to add a keyword, under a selected keyword, may allow the user to access the stated functionality by clicking on the hyperlink portion of the sentence. The addition of keywords to the knowledge management system by the user through the keyword maintenance portion of the keyword administration window may allow for expansion of knowledge management system classification and may allow for further refinement by the user.

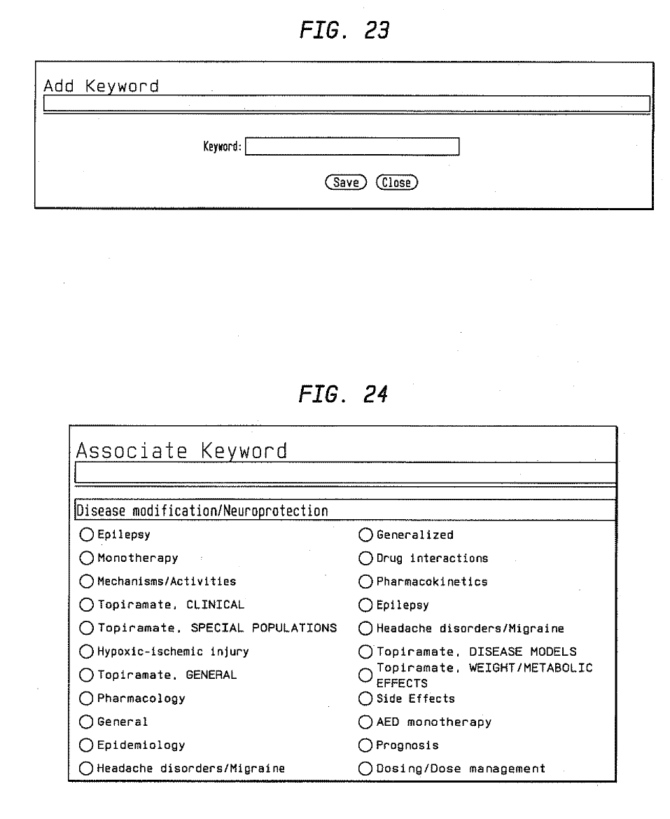

By choosing the “Click Here” hyperlink associated with adding keywords to the knowledge management system, the user may access the add keyword window, as illustrated in FIG. 23. Keywords may be added as top level words (Level 0), or as sublevel categories or lower level words such as, for example, Level 1 and Level 2 keyword subcategories under the top level. From the keyword maintenance portion of the keyword administration window, the user may add a keyword under the already selected keyword, such as from the first word under the keyword administration window, may add a new top level keyword, may change the selected keyword parent or top level association, may edit the selected keyword or delete the selected keyword, for example. If a user chooses to add a new top level keyword and clicks the associated hyperlink from the keyword maintenance portion, the user may be prompted to enter a keyword, as illustrated in FIG. 23. The user may be provided with a box wherein the desired keyword may be entered. Once the new top level keyword is entered, the user may click the save button from the add keyword window to add that particular keyword to the knowledge management system as a top level keyword. The completion of the addition of the new top level keyword may return the user to the keyword administration window and may show, in the first portion, the new top level keyword added, thereby allowing the user to further access the keyword administration tools. If a user desires to add a keyword under the newly added top level keyword, such as over a previously selected keyword from the first portion of the keyword administration window, regardless of in what level that keyword resides, the user may click the properly associated keyword from the keyword maintenance portion. Again, the user may be forwarded to the add key window illustrated in FIG. 23 and may complete the same steps as described above for the addition of the keyword to the knowledge management system.

To place a non-top level keyword within the hierarchy of the keyword contained in the knowledge management system, a user may be presented with the associated keywords window as illustrated in FIG. 24. This associated keyword window provides a list of all top level and non top level keywords contained within the knowledge management system. A newly entered keyword may be associated with any existing keyword, such as by clicking the button associated with one of the existing knowledge management system keywords. If the newly entered keyword is to be associated with more than one top level or non top level keyword, more than one keyword may be selected from the associate keyword window. Once the proper keyword or words have been selected, the user may click the save button at the bottom of the window to save the new keyword designations into the knowledge management system. The keyword maintenance portion further allows the user to change a selected keyword parent or associated higher level category. This functionality may also be controlled by the associate keyword window, such as by presenting to the user all of the keywords in the knowledge management system with the keywords associated with the selected keyword from the selected keyword administration window highlighted. A user may click and remove keywords from association with the selected keyword, and/or add keywords to be associated with the select keywords. All changes to the knowledge management system may be made by selecting the save button at the bottom of the window

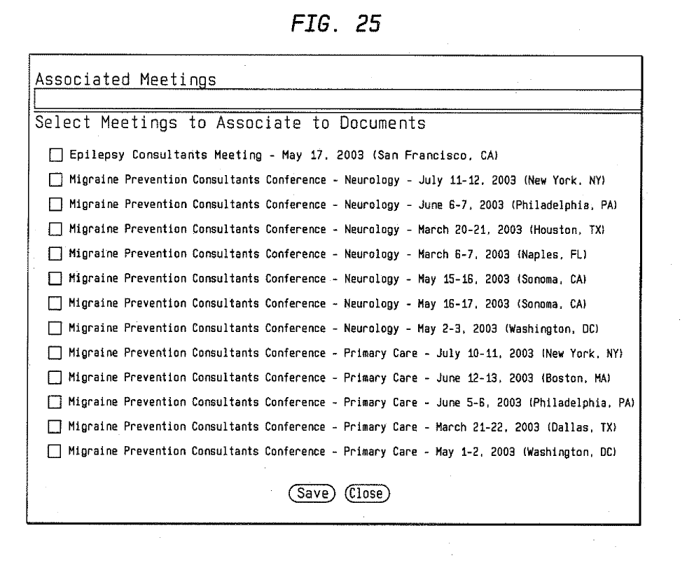

Once a document has been added to the knowledge management system, the user may specify additional unique document information to allow for further refinement of user searches. The more a user associates attributes and keywords with documents within the knowledge management system, the more robust the return search results will be. The knowledge management system may further contain a list of meetings, conferences and/or other events associated with the documents and contained within the knowledge management system. Documents within the knowledge management system may be associated with such meetings by clicking the hyperlink document name from the administration main window, as illustrated in FIG. 16. The user may then be forwarded to the associated meetings list, as illustrated in FIG. 25.

The user may further access the associated meetings list from the document maintenance window, as shown in FIG. 19, such as by clicking the meeting maintenance button. The associated meetings list window may include the title of a document for which meetings are desired to be associated, and a listing of meetings within the knowledge management system. The list of meetings may include information such as, for example, the title of the meeting, the date of the meeting and the location. Further, meeting information may be accessed by clicking on the title of the meeting, thereby allowing the user to “drill down” and view the information in the knowledge management system. The knowledge management system of the present invention may thus also include functionality similar to U.S. patent application Ser. No. 10/440,521, entitled System and Method for A Planner, herein incorporated in its entirety by reference.

The listing of meetings in a window may be sorted alphabetically by name, event date and/or location, for example. Each meeting may also have associated with it a box which may be selected by the user, or deselected by the user, to further associate the subject meeting. Clicking the save button at the bottom of the window may incorporate this information into the knowledge management system. Meetings listed in the associated meetings list may be of at least two types, such as meetings that have already occurred and meetings that may occur in the future. By listing meetings that have already occurred, users have the opportunity to associate documents that may have been presented at one or more meetings with the meeting or meetings. This will provide users not only the knowledge of when or where a given document is first presented or disclosed, but may also provide the user with desired previously provided information. This may be a strategic advantage for a user, allowing the user to understand what information attendees at a particular meeting may have already been exposed to and what focus information was deemed particularly useful or desirable.

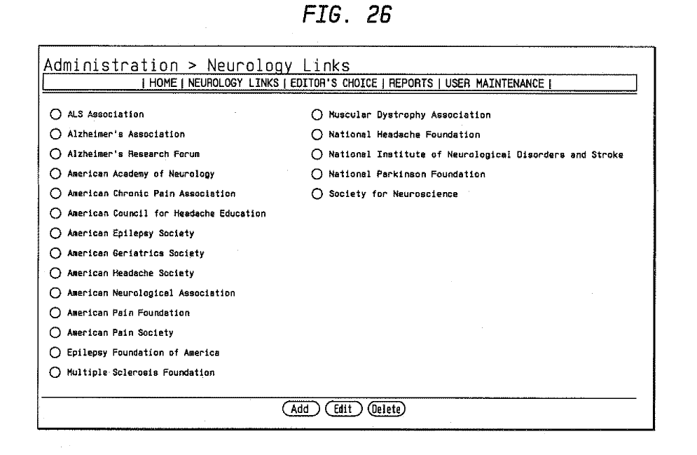

Further, those with administrative access to the knowledge management system may add, modify and remove external internet links from the associated links list window, such as from the knowledge management system administration window, as illustrated in FIG. 26, and an administrator may access the provided Internet link in the knowledge management system as shown in FIG. 28.

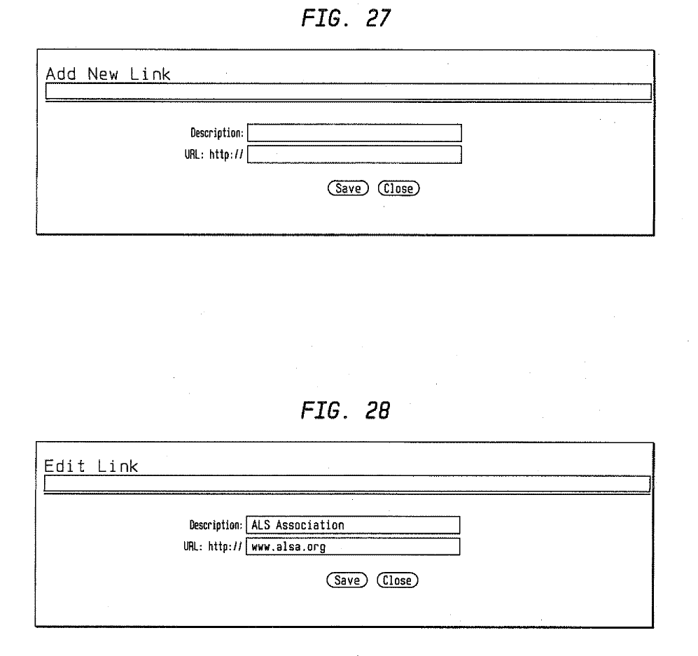

The link administration window may include a listing of all external internet links associated with the knowledge management system, or at least the portion of the knowledge management system over which the administration has control. The administrator may have the ability to add existing links, edit or delete new links. For example, the remote or external internet links listing may provide a button next to each external link. An administrator desirous to delete a particular link may click one or more of the buttons provided and click the delete button at the bottom of the window. The administrator may desire to add a link and may start that process by clicking the add button at the bottom of the window, which may provide the administrator with access to the add link window, as shown in FIG. 27. The add link window may provide two boxes, which may include, for example, the ability to enter a descriptive title for the link and a window wherein the link Internet address may be entered. When the proper description and internet address, such as a URL, for example, is entered, the administrator may click save at the bottom of the window to add the link to the knowledge management system. An administrator may also edit a selected link from the link administration window by choosing an existing link and clicking the edit button at the bottom of the window. This may provide the administrator access to the edit link window shown in FIG. 28. This window may also include a box wherein the descriptive title of the link and the Internet address or URL are shown if existent for the particular link. The administrator may alter either or both of the link or the address of the link, and may save these changes into the knowledge management system by clicking on the button shown in FIG. 28.

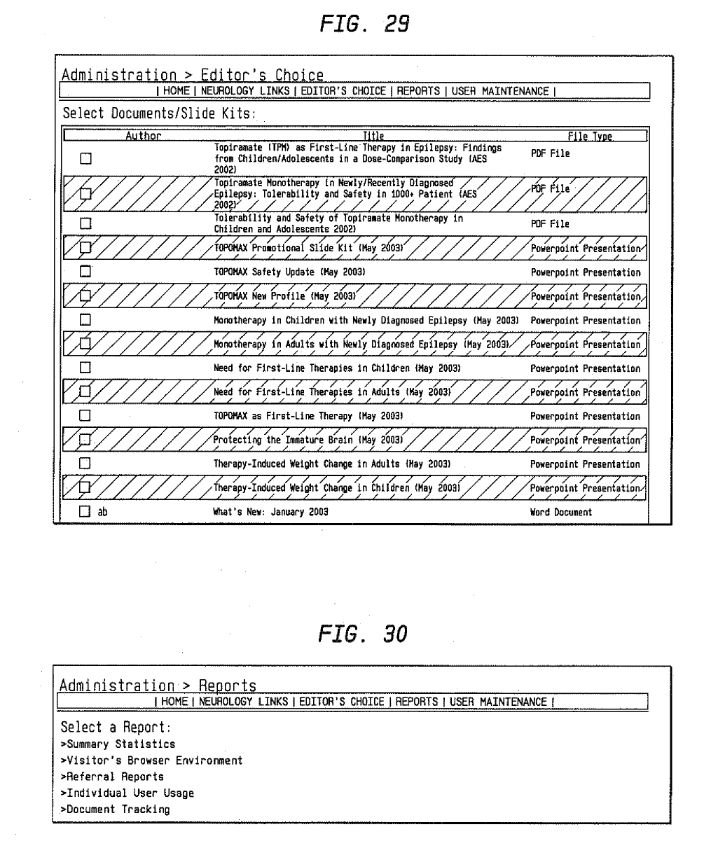

The knowledge management system may further provide additional functionality for the administrator by allowing the administrator to suggest or highlight documents within the knowledge management system as an editor's choice. By highlighting documents within the knowledge management system, an administrator may alert users to the importance of certain documents for purposes such as training, or for providing timely information in light of current events. For example, by clicking on the editor's choice button at administration window, the administrator may access the setting editor's choice window as shown in FIG. 29. This window may provide a listing of all documents within the knowledge management system sorted in a table format, for example. The documents listed may include information such as, for example, the author, title and file type. Each document may further be associated with a button which may allow the administrator to choose documents within the list. If documents within the list are currently selected as an editor's choice, the button associated with that document may already be marked. An administrator may click the button again to remove the mark, thus removing it from the editor's choice as seen by the users of the knowledge management system. To select a previously unselected document, the administrator may click an unmarked button to mark it and thus add to the editor's choice list as viewed by the users of the knowledge management system. An administrator may further leave unchanged documents currently associated with the editor's choice listing. Changes to this list may be saved to the knowledge management system by clicking on the bottom of the window.

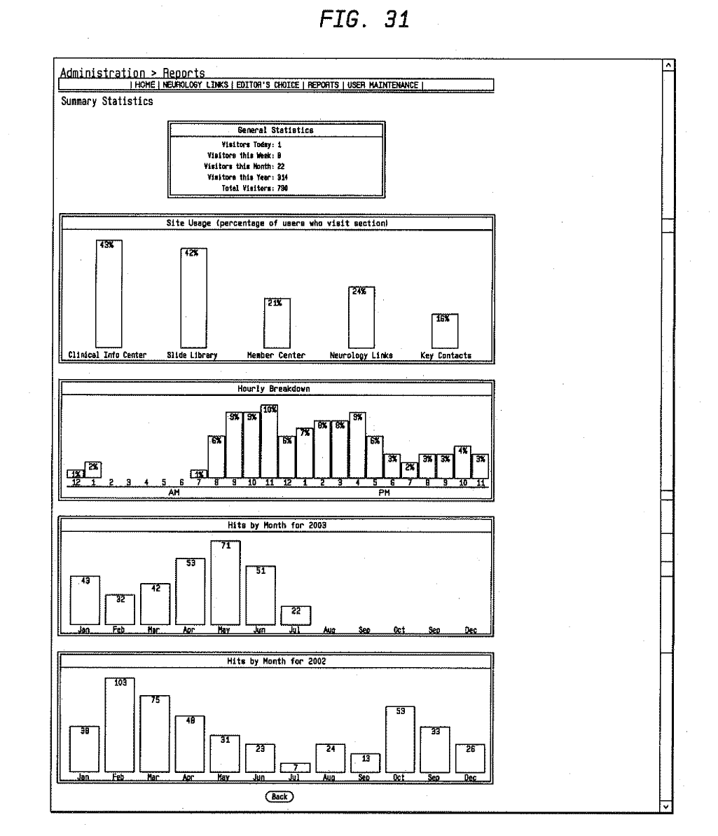

The knowledge management system may further provide an administrator with access to reporting functionality, as shown in FIG. 30. The reports available to the administrator in the report list window may include, for example; summary statistics, visitor browser environment, referral report, individual user usage and document tracking. These reports may also be accessed by clicking the hyperlink entitled the same. For example, by clicking the hyperlink entitled summary statistics, the administrator may access to the summary statistics report window illustrated in FIG. 31. The summary statistics report window may include general statistics about the users and uses of the knowledge management system. The summary statistics window may include a table entitled “general statistics” which may provide a count of the visitors or users of the knowledge management system for the chosen day, the number of visitors for the chosen week, the number of visitors for the chosen month, the number of visitors for the given year, and the total visitors or users of the knowledge management system since its inception, for example. The statistics report may also provide a table outlining uses. The site usage report may outline the percentage of users revisiting various sections of the knowledge management system. By way of non-limiting example only, the site usage graph may show that, of all users of the knowledge management system sixteen (16%) percent have visited the key contacts portion of the knowledge management system, while twenty-one (21%) percent have visited the member center portion of the knowledge management system.

A graph incorporated in the statistics report may be, for example, an hourly breakdown graph. This graph may illustrate the usage of the knowledge management system during a twenty-four hour period. By way of non-limiting example only, the hourly breakdown may show that during the time period from 3:00 am to 5:00 am the percentage of users using the knowledge management system is zero, while that same time period in the pm, twenty-three (23%) percent of users registered on the knowledge management system access and use the knowledge management system. The statistics report may further contain graphs illustrating the hit by month for the current year, and for previous years the knowledge management system has been in use. By way of non limiting example only, a table illustrating the hits by month of the current year may show that during the month of May, there were seventy-one hits compared to thirty-one hits in the same month for the previous year.

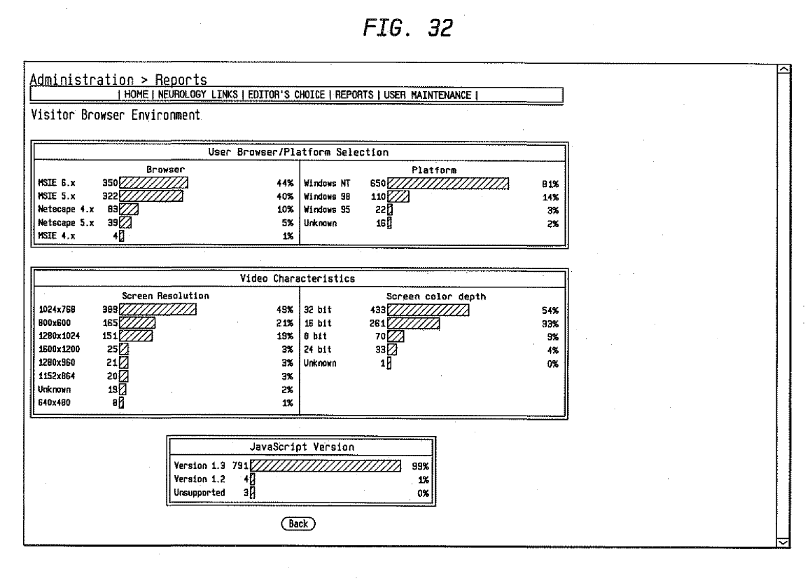

The knowledge management system may also provide a visitor browser environment report window, illustrated in FIG. 32, which may display information about user tools such as, for example, the browser platform and screen settings used by the user. This report may include a table showing user, browser/platform selections statistics wherein browser information includes the type of browser, the number of users using that type of particular browser, and the percentage those users use compared to all browser information. For example, the browser portion of the user browser/platform selection graph may include browser, such as MSIE 6.x, MSIE 5.x, Netscape 4.x, Netscape 5.x and MSIE 4.x, for example. By way of non-limiting for example only, the browser portion may show that 350 users utilized the MSIE 6.x browser, thus representing 44% if all users, while ten (10%) percent of all users utilize the Netscape 4.x browser. The platform portion of the graph may include platforms such as Windows NT, Windows 98, Windows 95 and Unknown. By way of non-limiting example only, eighty-one (81%) of users may use the Windows NT platform, while three percent (3%) of users may use the Windows 95 platform.

A table included in the visitor browser environment report may contain video characteristics. These video characteristics may include information regarding screening resolutions and screened color set. Screening resolution may be broken down into categories such as, for example, 1024×768, 800×600, 1280×1024, 1600×1200, 80×960, 1152×864, Unknown, and 640×480, by way of non-limiting example only. The screen resolution portion of the table may illustrate that forty-nine (49%) percent have screen resolutions of 1024×768, while just three percent of users have a screen resolution of 1152×864. The screen color debt portion of the table may include color debt values of, for example, 32 bit, 16 bits, 24 bits, and unknown. By way of non-limiting example only, this portion of the table may illustrate that fifty-four (54%) percent have a color depth of 32 bits, while just four percent (4%) of users have a color depth of 24 bits. The visitor browser environment report window may further include a table which may provide information about the version of job descriptions used. This table may include the listing of Version 1.2 or versions that are unsupported, for example. By way of non-limiting example only, ninety-nine (99%) percent of users may use Version 1.3 while one (1%) percent of users utilize Version 1.2.

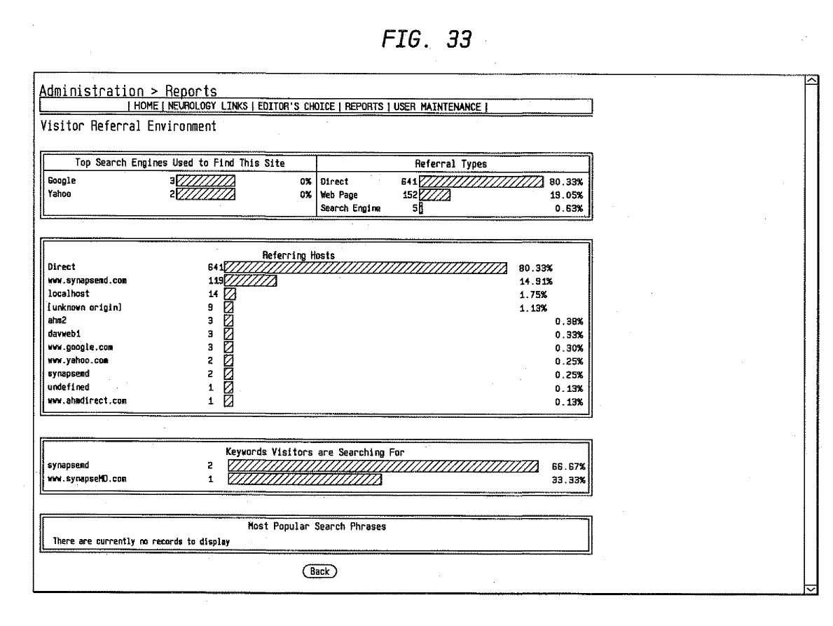

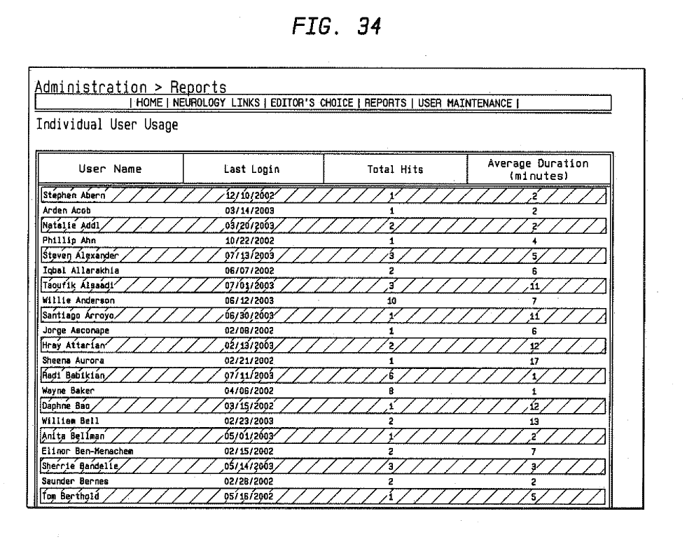

An administrator to the knowledge management system may also have access to the visitor referral information report window, as illustrated in FIG. 33, which may provide information on how users were referred to the knowledge management system. This report may provide the administrator with information, such as the search engines used to find the knowledge management system. The referral types, the referring hosts, keywords visitors are searching for, and most popular search phrases used by users may be reported, for example. Information relating to search engines used to find the knowledge management system site may include, for example, the list of searches by Google and Yahoo, for example. This information may also provide the number of users guided from the designated search engine, and the percentage of search engines.

Referral types may include direct referrals, web page referrals or search engine referrals. Direct referrals may include access to the site by the user directly typing into a browser the Internet address for the knowledge management system web site. Web page referrals may be the number of users who access the site from links such as, for example deep links within other web pages. Search engine referral types may include the number of users directed to the knowledge management system web site from a search engine. The referral type information may also include the number of users referred to the site by type, and the percentage of users that type represents. The visitor referral report window may also provide information about the referring host.

This list may include the search engine name or web site address of the user's referral. This report may also include a listing of keywords used in search engines which ultimately directed the user to the knowledge management system. This listing may, for example, include the name of the knowledge management system or the internet address of the knowledge management system, or names of documents in the knowledge management system. This information may also provide the number of users associated with each keyword used within the search engine, and the percentage of search engine users represented. The report may also provide a list of the most popular search phrases used to find and navigate to and within the knowledge management system.

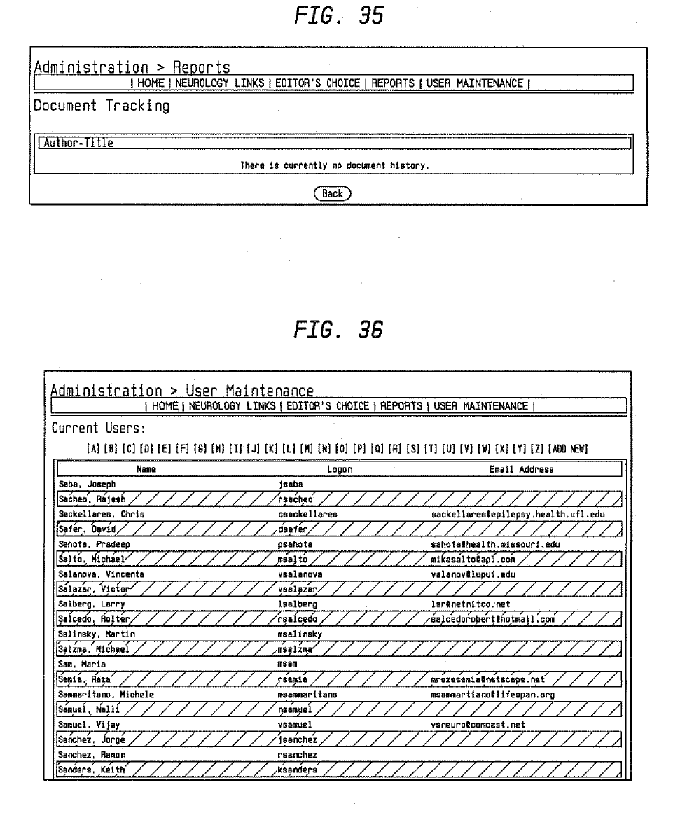

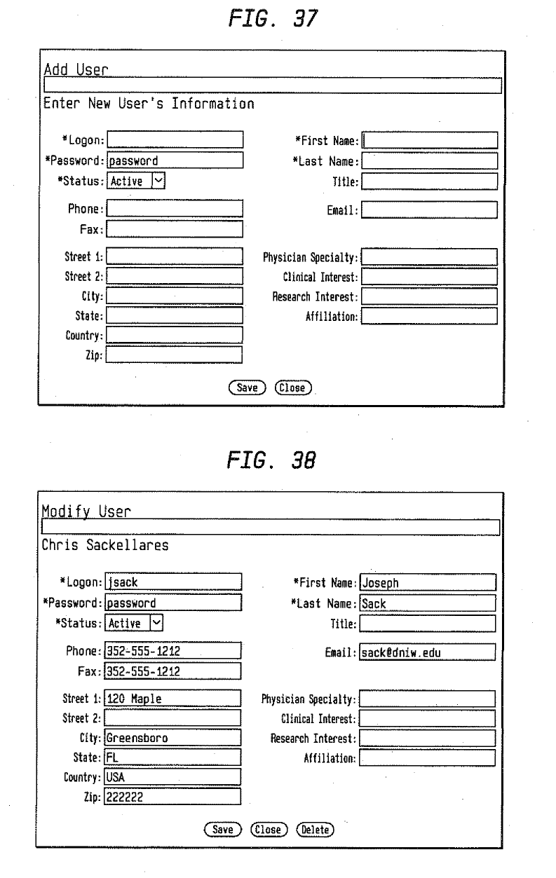

An administrator may further have access to a user usage search report as illustrated in FIG. 32. This report provides a list which may contain user name, last login date, total number of logins, and the average duration of the login. An administrator may further have access to the document tracking report window, as illustrated in FIG. 35, which may provide the administrator with a list of the documents from within the knowledge management system, and an access and download associated with users of the knowledge management system. The knowledge management system may also allow the administrator to add, delete or modify a user account. Modification of an account may include changing the name and title of users, as well as access level, contact information, specialty, interests and affiliations, for example. From the knowledge management system administration window, the administrator may click the user maintenance button to gain access to the user maintenance window illustrated in FIG. 36. The user maintenance window may list the users of the knowledge management system alphabetically by last name, and may indicate logon name and email address, for example. Current users may be sorted and searched by the first letter of the last name, for example, by clicking on the appropriate letter within the hyperlink of the alphabet provided at the top of the window. An administrator may add a new user to the knowledge management system by clicking the add new button, which may provide access to the add/edit user window, illustrated in FIG. 37. This window may allow the entry of information for the new user, such as logon names, password, status, contact information, title, specialty, areas of interest and affiliation, for example. This information may be saved by clicking on the save button at the bottom of the. Further, from the user maintenance window, an administrator may modify the existing user or delete an existing user by accessing the modify user window, as illustrated by FIG. 38, by clicking on the name of the user from the user maintenance window. The modify user window may include the same information as the Add/Edit user window, but may be populated with information that already exists in the knowledge management system. The administrator may change any portion of the information already existing in the knowledge management system. The modify user window may also have a button marked “delete” that may delete the existing user by the administrator. If any information is changed, the administrator may click the save button at the bottom of the window. The administrator may alternately close the window by clicking the close button, and may not save any changes to the knowledge management system.

It will be apparent to those skilled in the art that various modifications and variations may be made in the apparatus and process of the present invention without departing from the spirit or scope of the invention. Thus, it is intended that the present invention cover the modification and variations of this invention provided they come within the scope of the appended claims and the equivalents thereof.

What is claimed is:

1. A computer-readable medium comprising computer-executable instructions for managing information associated with a plurality of electronic documents, said computer-executable instructions comprising:
instructions for displaying a hierarchically organized list of user selectable keywords;
instructions for associating at least some of the electronic documents with selected ones of the keywords;
instructions for associating at least some of the electronic documents with at least one meeting, conference or event; and
instructions for automatically displaying a list of ones of the electronic documents associated with at least one of the keywords and meetings, conferences or events responsively to a user request therefore.

2. The computer-readable medium of claim 1, further comprising instructions for automatically displaying a list of ones of the electronic documents associated with a date responsively to a request therefore.

3. The computer-readable medium of claim 1, further comprising instructions for automatically displaying a list of ones of the electronic documents associated with a source responsively to a request therefore.

4. The computer-readable medium of claim 1, further comprising instructions for automatically displaying a list of ones of the electronic documents associated with an author responsively to a request therefore.

5. The computer-readable medium of claim 1, further comprising instructions for automatically displaying a list of ones of the electronic documents associated with a title responsively to a request therefore.

6. The computer-readable medium of claim 1, further comprising instructions for automatically displaying a list of ones of the electronic documents associated with an electronic document type responsively to a request therefore.

7. The computer-readable medium of claim 1, further comprising instructions for automatically presenting a link to other information associated with the information associated with the stored documents.

8. The computer-readable medium of claim 1, further comprising instructions for automatically displaying a list of persons associated with the information associated with the stored documents.

9. The computer-readable medium of claim 8, wherein the list of persons comprises at least two of: name, telephone number, contact address, e-mail address, professional affiliation, company and title.

10. The computer-readable medium of claim 8, wherein the list of persons comprises at least three of: name, telephone number, contact address, e-mail address, professional affiliation, company and title.

11. The computer-readable medium of claim 1, wherein the electronic documents include at lease some of: .PDF, .PPT, .DOC, .TXT and .WPD documents.

12. The computer-readable medium of claim 1, wherein the electronic documents include: .PDF, .PPT, .DOC, .TXT and .WPD documents.

13. The computer-readable medium of claim 1, further comprising instructions for allowing a user to enter a new keyword into the hierarchical list of keywords stored in at least one database.

14. The computer-readable medium of claim 13, further comprising instructions for allowing a user to delete a keyword from the hierarchical list of keywords stored in at least one database.

15. The computer-readable medium of claim 1, wherein at least some of the meetings, conferences or events are past meetings, conferences or events.

16. The computer-readable medium of claim 1, wherein at least some of the meetings, conferences or events are future meetings, conferences or events.
